(19) United States
(12) Patent Application Publication
(10) Pub. No.: US 2012/0228116 A1
(43) Pub. Date: Sep. 13, 2012

(54) Vacuum Evaporator / Distillation System

(75) Inventor: Michael Presutti, Export, PA (US)

(73) Assignee: ENVIRONMENTAL PROCESS SOLUTIONS LLC, McKeesport, PA (US)

(21) Appl. No.: 13/042,789

(22) Filed: Mar. 8, 2011

(51) Int. Cl. B01D 3/10; B01D 3/00; B01D 1/26

(52) U.S. Cl. 203/4; 159/17.2; 202/174; 203/81; 203/80

(57) ABSTRACT

An evaporator or distillation apparatus includes an inlet supply line for supplying an influent liquid, a heater configured to heat the influent liquid supplied by the inlet supply line, and a plurality of cells. Each cell includes an outer surface defining an interior chamber, an inlet, a vapor outlet, a concentrate outlet, and an inner conduit in fluid communication with the inlet. At least a portion of the inner conduit is positioned within the interior chamber. The vapor outlets of the plurality of cells are connected to each other in a parallel configuration and the inlet supply line is connected to the inlet of each cell.

### BACKGROUND OF THE INVENTION

1. Field of the Invention

The present invention generally relates to an evaporator or distillation system and, more particularly, a vacuum evaporator or distillation system for the separation of a liquid with a lower vapor pressure from a liquid with a higher vapor pressure or the separation of a liquid from a dissolved solid.

2. Description of Related Art

Distillation columns are frequently used to separate mixtures based on differences in the conditions necessary to the change the phase of the components of the mixture. A mixture of liquids, for instance, may be separated by heating and boiling the mixture so that one of the liquids enters the gas phase, which can be condensed, returned to the liquid phase, and collected. In vacuum distillation systems, the distillation column is typically placed under a vacuum thereby reducing the pressure within the column to a level closer to or below the vapor pressure of components of the mixture. As boiling occurs when the vapor pressure of a liquid exceeds the ambient pressure, vacuum distillation systems can operate without heating the mixture or operate at lower temperatures than columns operated at atmospheric pressures.

U.S. Pat. No. 2,724,709 to Spence discloses a vacuum fractional distillation apparatus having an evaporator surmounted by a plurality of columns with each of the columns having overhead condensers. The upper ends of the condensers are each connected to a common vacuum head to which a vacuum is applied. The evaporator is divided into a plurality of vapor compartments by transverse baffle means. Product can be withdrawn from the condensers via lines, valves, and barometric legs.

U.S. Pat. No. 4,678,543 to Houben et al. discloses an apparatus for producing various forms of alcohol, namely ethanol, having a plurality of columns in the individual processing stages that are connected in parallel for product flow but in series for energy flow and conservation. As shown in FIG. 2, a product will flow through a first distillation column to a first rectifying column and a second product will flow through a second distillation column to a second rectifying column while the energy or heat flows through successively.

U.S. Patent Application Publication No. 2009/0297431 to McGinnis et al. discloses a plurality of distillation columns having a draw solution directed to the columns in parallel while the energy stream is directed to the columns in series. The columns operate in a multi-stage process with the columns being designed so that they differ in the temperature and pressure in which they operate.

U.S. Pat. Nos. 5,853,549 and 6,309,513 to Sephton disclose a desalination system having a multi-stack vertical tube evaporator having units of multiple stacks of vertical tube bundles or stages mounted in a single vessel. The liquid feed is pumped to the uppermost bundle stack or stage with the feed cascading downward through the lower bundle stacks in series flow.

U.S. Pat. No. 1,361,416 to Tayntor discloses an apparatus for the production of acids having a plurality of stills connected to a common expansion chamber, which is in turn connected to bleachers and condensers.

### SUMMARY OF THE INVENTION

In one embodiment, an evaporator or distillation apparatus includes an inlet supply line for supplying an influent liquid, a heater configured to heat the influent liquid supplied by the inlet supply line, and a plurality of cells. Each cell includes an outer surface defining an interior chamber, an inlet, a vapor outlet, a concentrate outlet, and an inner conduit in fluid communication with the inlet. At least a portion of the inner conduit is positioned within the interior chamber. The vapor outlets of the plurality of cells are connected to each other in a parallel configuration and the inlet supply line is connected to the inlet of each cell.

The apparatus may further include packing material positioned within the interior chamber of each cell. The packing material may be positioned between the inlet and an upper end of the inner conduit of each cell. The apparatus may also further include a mist eliminator positioned within the interior chamber of each cell. The mist eliminator may be positioned between the vapor outlet and the upper end of the inner conduit of each cell. The apparatus may further include a tank for storing the influent liquid with the inlet supply line being in fluid communication with the tank. The apparatus may also further include a heat exchanger in fluid communication with the vacuum pump via a vapor supply line with the heat exchanger having a distillate outlet. The heat exchanger may be a water cooled condenser having a coolant pump connected to a closed-loop coolant line with a portion of the coolant line positioned within the tank for storing the influent liquid. The apparatus may include a vacuum pump in fluid communication with the vapor outlet of each cell.

In a further embodiment, a method of evaporating or distilling includes: supplying an influent liquid to a plurality of cells; circulating the influent liquid through a heater and into the plurality of cells; vaporizing a portion of the influent liquid; and collecting the vaporized portion of the influent liquid via a vapor supply line. The vapor supply line connects a vapor outlet of each of the plurality of cells in a parallel configuration.

The method may further include applying a vacuum to the plurality of cells such that a pressure within the cells is reduced. The vacuum applied to the plurality of cells may be about 1-10 Torre. The method may also include compressing the vaporized portion of the influent liquid from the vapor supply line, and condensing the vaporized portion of the influent liquid. The vaporized portion of the influent liquid may be condensed by passing the vaporized portion of the influent liquid through a water-cooled condenser. The method may include circulating coolant through a closed-loop coolant line with a portion of the closed-loop coolant line being positioned within a tank for storing the influent liquid such that heat is transferred from the vaporized portion of the influent liquid to the influent liquid positioned within the tank. The method may further include passing the liquid influent across a packing material positioned within each of the plurality of cells such that a portion of the liquid influent is dispersed into a film. Each of the plurality of cells may have substantially the same temperature and pressure during vaporizing of the influent liquid. The method may also include cleaning one of the plurality of cells while the remaining cells of the plurality of cells continue to receive the circulated influent liquid.

### BRIEF DESCRIPTION OF THE DRAWINGS

FIG. 1 is a schematic view of an evaporator or distillation apparatus according to one embodiment of the present invention;

FIG. 2 is a partial cross-sectional view of a cell shown in FIG. 1 according to one embodiment of the present invention;

FIG. 3 is a front perspective view of an evaporator or distillation apparatus according to one embodiment of the present invention;

FIG. 4 is a rear perspective view of the apparatus shown in FIG. 3;

FIG. 5 is a top view of the apparatus shown in FIG. 3;

FIG. 6 is a left side view of the apparatus shown in FIG. 3;

FIG. 7 is a front view of the apparatus shown in FIG. 3;

FIG. 8 is a right side view of the apparatus shown in FIG. 3;

FIG. 9 is an exploded perspective view of the apparatus shown in FIG. 3; and

FIG. 10 is a detail view of area “A” shown in FIG. 9.

### DESCRIPTION OF THE PREFERRED EMBODIMENTS

The present invention will now be described with reference to the accompanying figures. For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is to be understood that the specific apparatus illustrated in the attached figures and described in the following specification is simply an exemplary embodiment of the present invention. Hence, specific dimensions and other physical characteristics related to the embodiments disclosed herein are not to be considered as limiting.

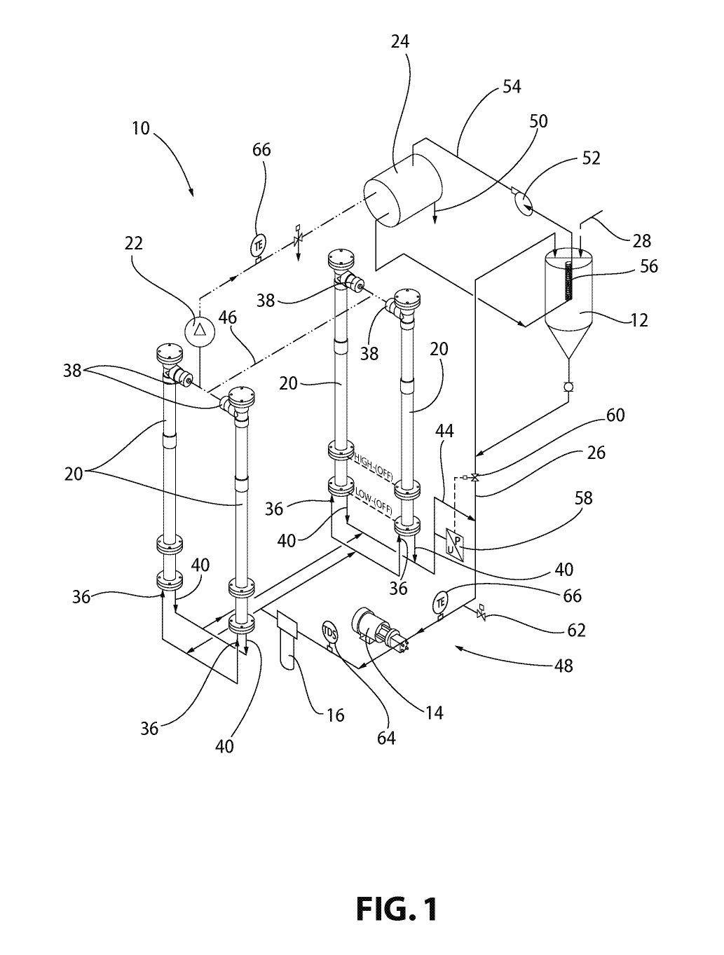

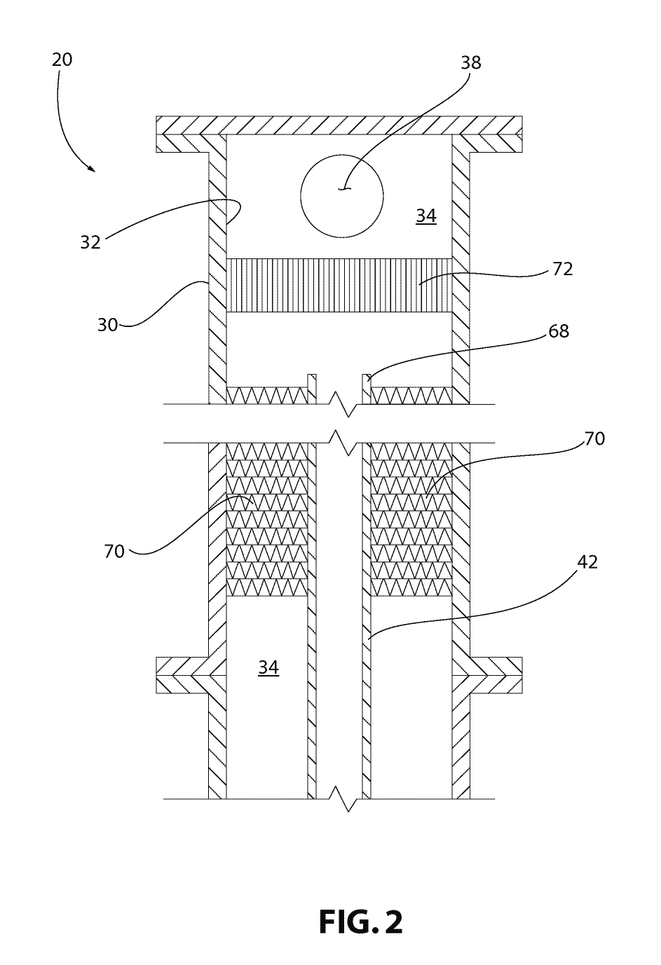

Referring to FIGS. 1 and 2, one embodiment of an evaporator or distillation apparatus 10 includes a tank 12 for storing influent liquid, a recirculation pump 14, a heater 16, a plurality of cells 20, a vacuum pump 22, and a heat exchanger 24. The tank 12 is connected to and in fluid communication with the plurality of cells 20 via an inlet supply line 26. An influent liquid supply line 28 is connected to the tank 12 for supplying the tank 12 with influent liquid. The recirculation pump 14 and heater 16 are connected to and in fluid communication with the inlet supply line 26. The recirculation pump 14 and heater 16 are configured to circulate and heat the influent liquid supplied form the tank 12. Each of the plurality of cells 20 includes an outer surface 30 and inner surface 32 to define an interior chamber 34. Although four cells 20 are shown in FIG. 1, two or more cells 20 may be provided. Each of the cells 20 also includes an inlet 36, a vapor outlet 38, a concentrate outlet 40, and an inner conduit 42 positioned within the interior chamber 34. The inner conduit 42 is connected to and in fluid communication with the inlet 36. The outer surface 30 and the inner surface 32 of each cell 20 may be defined by a pipe or tube having a relatively small diameter such as a nominal pipe size of 2-6″, although other suitable size pipes may be utilized. The pipes may be constructed of common material and schedules such as PVC, FRP, aluminum, and stainless steel. For example, the pipes may be schedule 40 or 80 PVC pipe.

The inlet supply line 26 is connected to the inlet 36 of each cell 20 in a parallel configuration. The concentrate outlets 40 of the cells 20 are also connected to each other in a parallel configuration with a return line 44 connected to and in fluid communication with the concentrate outlets 40 and extending to the inlet supply line 26. The vapor outlets 38 of each of the cells 20 are connected to each other in a parallel configuration with a vapor supply line 46 being connected to and in fluid communication with the vapor outlets 38. A portion of the inlet supply line 26 and the return line 44 define a circulation loop 48. The vacuum pump 22 is connected to the vapor supply line 46 and is in fluid communication with each vapor outlet 38 of the cells 20. The vacuum pump 22 is configured to apply a vacuum to the plurality of cells 20 to reduce the pressure within the interior chamber 34 of the cells 20. The vacuum pump 22 also compresses and heats vapor from the vapor outlets 38 as it passes through the vacuum pump 22. For example, the vacuum pump 22 may apply of vacuum of about 1-10 Torre.

The heat exchanger 24 is connected to the vapor supply line 46. The heat exchanger 24 may be a water-cooled condenser, although other types of condensers or various liquid vapor phase separators may be utilized. The heat exchanger 24 condenses the vapor from the vapor supply line 46 and produces a distillate that exits the heat exchanger 24 via a distillate outlet 50. The heat exchanger 24 also includes a coolant pump 52 connected to a closed-loop coolant line 54. The closed-loop coolant line 54 includes a coiled portion 56 positioned within the tank 12 to transfer heat during condensing of the vapor to the influent liquid stored within the tank 12.

Referring again to FIG. 1, the return line 44 includes a pressure transducer 58 configured to measure the level of liquid within the plurality of cells 20. The pressure transducer 58 is connected to and in electronic communication with a solenoid valve 60 positioned upstream from the connection of the return line 44 and the inlet supply line 26. The solenoid valve 60 is positioned outside of the circulation loop 48. The solenoid valve 60 is configured to open or close based on the measurements from the pressure transducer 58. Although a pressure transducer 58 and solenoid valve 60 are utilized, other suitable sensors and valves may be used. A concentrate dump valve 62 is connected to the inlet supply line 26 within the circulation loop 48 and is configured to open when a predetermined concentration level of the circulated liquid is reached to remove a volume of the concentrated liquid. As shown in FIG. 1, a sensor 64 is provided to monitor the concentration of total dissolved solids, although other types of sensors may be provided to measure other concentration values, such as salinity concentration. Based on information from the sensor 64, the concentrate dump valve 62 may be actuated to an open position to release a volume of the liquid. Temperature sensors 66 are also connected to the inlet supply line 26 within the circulation loop 48 and to the vapor supply line 46 to monitor the operating temperatures of the evaporator or distillation apparatus 10. Although not shown, the evaporator or distillation apparatus 10 may also include a vacuum gauge to monitor the vacuum being applied to the cells 20.

Referring to FIG. 2, the inner conduit 42 is positioned within the interior chamber 34 of each cell 20 with an upper end 68 of the inner conduit 42 being positioned intermediate opposite ends of each cell 20. Each of the cells 20 includes packing material 70 positioned within the interior chamber 34. The packing material 70 may be positioned between the inlet 36 and the upper end 68 of the inner conduit 42 of each cell 20. Each of the cells 20 may also include a mist eliminator 72 positioned within the interior chamber 34 of each cell 20. The mist eliminator 72 may be positioned between the vapor outlet 38 and the upper end 68 of the inner conduit 42 of each cell 20.

Referring again to FIGS. 1 and 2, one embodiment of a method of distillation includes supplying an influent liquid to the plurality of cells 20 and circulating the influent liquid through the heater 16 and into the plurality of cells 20. The method further includes vaporizing a portion of the influent liquid and collecting the vaporized portion of the influent liquid via the vapor supply line 46.

The influent liquid may be supplied from the tank 12 to the cells 20 with the inlet supply line 26 via gravity or a feed pump (not shown). When the liquid level within the cells 20 reaches a predetermined level as measured by the pressure transducer 58, power is removed from the normally closed solenoid valve 60 and the supply from the tank 12 is stopped. The recirculation pump 14 is energized and circulates liquid through the heater 16 and into the plurality of cells 20. The influent liquid is pumped through the inner conduit 42 of each cell 20. The length of the inner conduit 42 may vary depending on the particular application. Liquid exiting the upper end 68 of the inner conduit 42 is diverted back-down through each cell 40 between the inner conduit 42 and the inner surface 32 of each cell 20 past the packing material 70 to disperse the liquid into a fine film. The liquid is heated to a temperature that permits the system to operate at the highest efficiency at a given vapor pressure. The heater 16 is connected to the temperature sensor positioned within the circulation loop 48. The heater 16 is configured to energize or de-energize the heating element (not shown) of the heater 16 to precisely control the temperature of the liquid being circulated in the circulation loop 48.

The method may further include applying a vacuum to the plurality of cells 20 to reduce the pressure within the cells to a level that permits vaporization at significantly reduced temperatures. As noted above, a vacuum of about 1-10 Torre may be applied to the cells 20 using the vacuum pump 22. The plurality of cells 20 may be under a continuous vacuum with a portion of the influent liquid being vaporized as the liquid is dispersed into a fine film as discussed above. The method may also include compressing the vaporized portion of the influent liquid. In particular, the vapor temperature of the vapor is increased by mechanical compression through the vacuum pump 22. After passing through the vacuum pump 22, the vapor will condense to a liquid distillate upon exiting at atmospheric pressure and temperature. The vapor, however, may be piped to the heat exchanger 24 to collect the distillate via the distillate outlet 50. The apparatus 10 may be operated wither as an evaporator or as a distillation system. In particular, the apparatus 10 will operate as an evaporator when the vapor from the vacuum pump 22 is not further sent to condensation and will operate as a distillation system when the vapor exhaust is condensed via water or air-cooled condenser.

As discussed above, the waste heat from the vacuum pump 22 may be recovered using the coolant pump 52 and closed-loop coolant line 54. The closed-loop coolant line 54 circulates through the heat exchanger 24 with a portion of the coolant line 56 being positioned within the tank 12 thereby preheating the influent liquid and reducing the energy required to heat the incoming liquid. In one example, the waste heat may be directly recovered from the vacuum pump 22 rather than being recovered from the vapor exiting the vacuum pump 22. Similar to the closed-loop coolant line 54 shown in FIG. 1, a closed loop cooling system (not shown) may circulate coolant from a storage tank (not shown) and pump coolant into a spiral heat exchanger and into a coil located in the storage tank 12 (similar to coiled portion 56). The coolant may be a water glycol solution, although other suitable coolants may be utilized. The heat generated by the vacuum pump 22 is transferred to the coolant which in turn is transferred to the influent liquid thereby preheating the solution. If the coolant reaches a temperature greater than the acceptable cooling required by the vacuum pump 22, a valve (not shown) will open and permit cold water to enter the opposing side of the heat exchanger thereby reducing the temperature of the coolant.

The method may also include cleaning one of the plurality of cells 20 while the remaining cells continue to receive the circulated influent material. In particular, the evaporator or distillation apparatus may be operated continuously by isolating a segment of the cells 20 in parallel and performing a cleaning via high pressure low volume acidic wash while the remaining cells 20 are operating under circulation and vacuum.

The evaporator/distillation apparatus and method described above may be utilized in the separation of a liquid with a lower vapor pressure from a liquid with a higher vapor pressure or the separation of a liquid from a dissolved solid. Thus, the influent liquid discussed above may include a liquid/liquid, a liquid/Total Dissolved Solids (TDS), or any other liquid capable of being evaporated or distilled. In particular, the evaporator/distillation apparatus and method may be utilized for the evaporation or distillation of water to remove high concentrations of TDS, the desalinization of sea water to produce potable water, the recovery of Reverse Osmosis rejects water to provide a closed loop process, and the recovery of lubrication oil by water contamination. The evaporation/distillation apparatus and method may also be utilized in the production of spirits, bio-fuels, ethanol's, alcohols, and fragrances. The evaporator/distillation apparatus and method utilizes a single-effect process with the cells operating at substantially similar temperatures and pressures. The evaporator/distillation apparatus and method allows multiple cell arrays to be configured in varying numbers to provide a high process throughput.

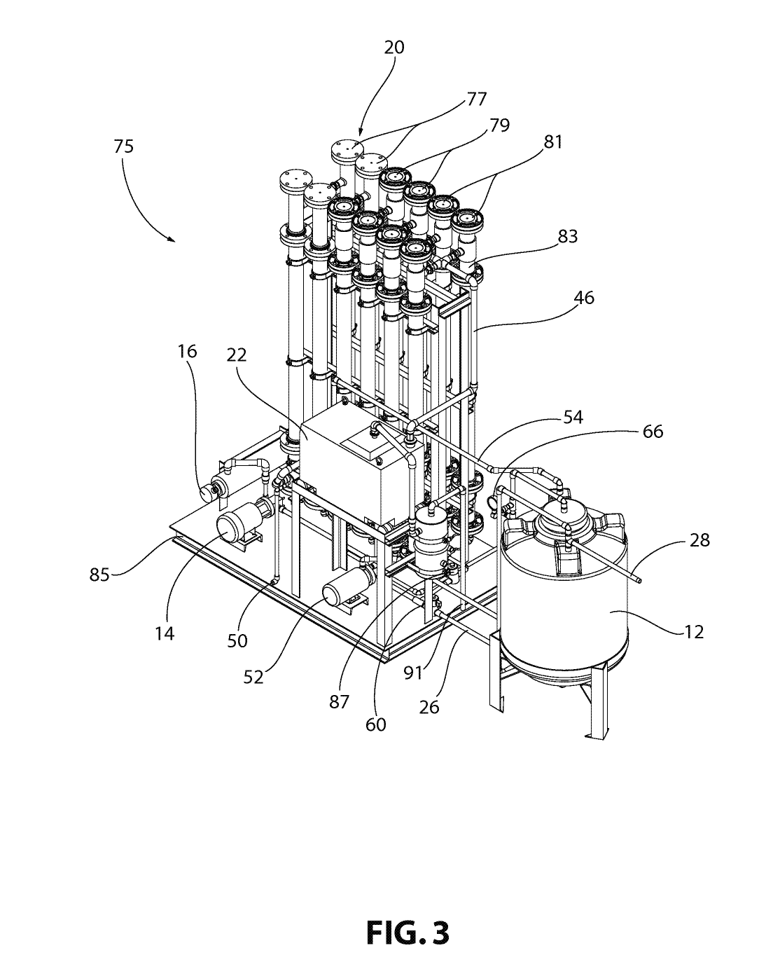

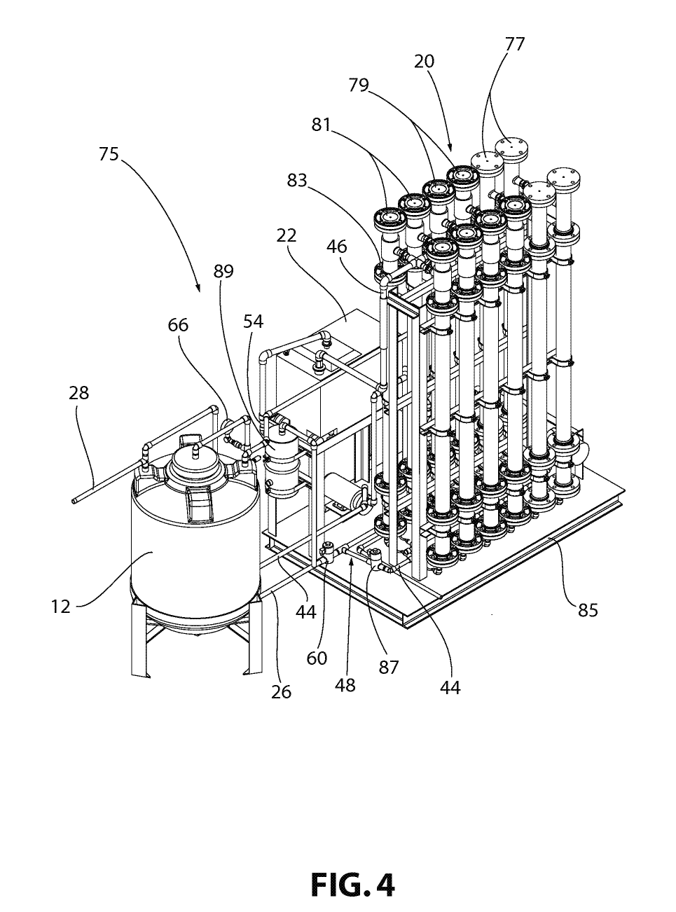

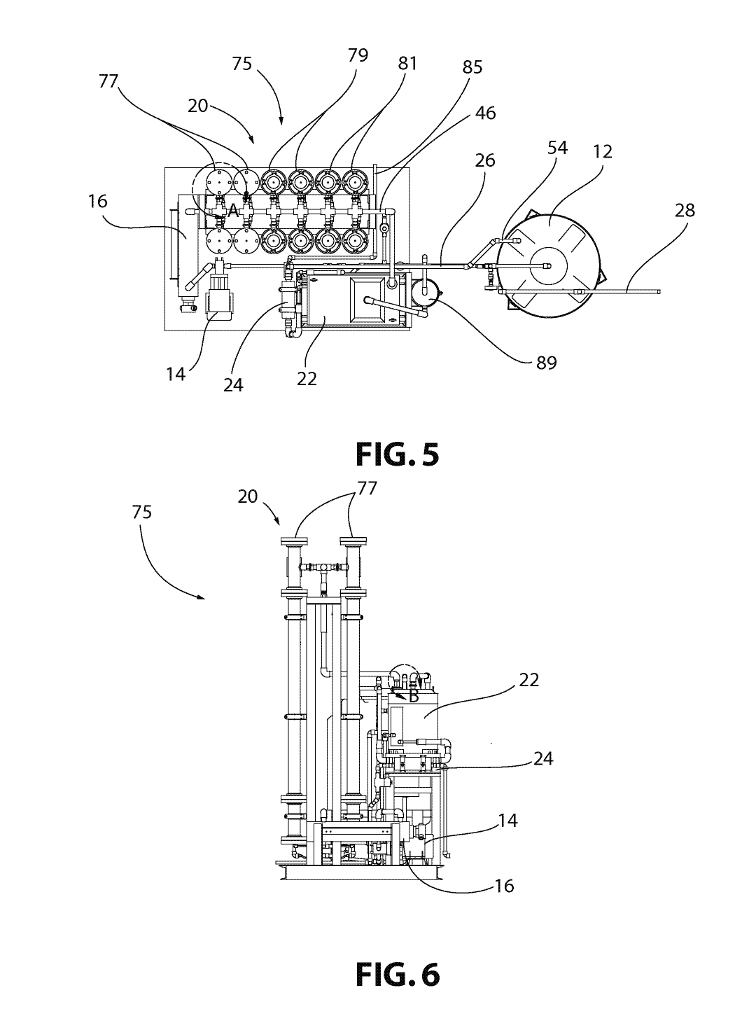

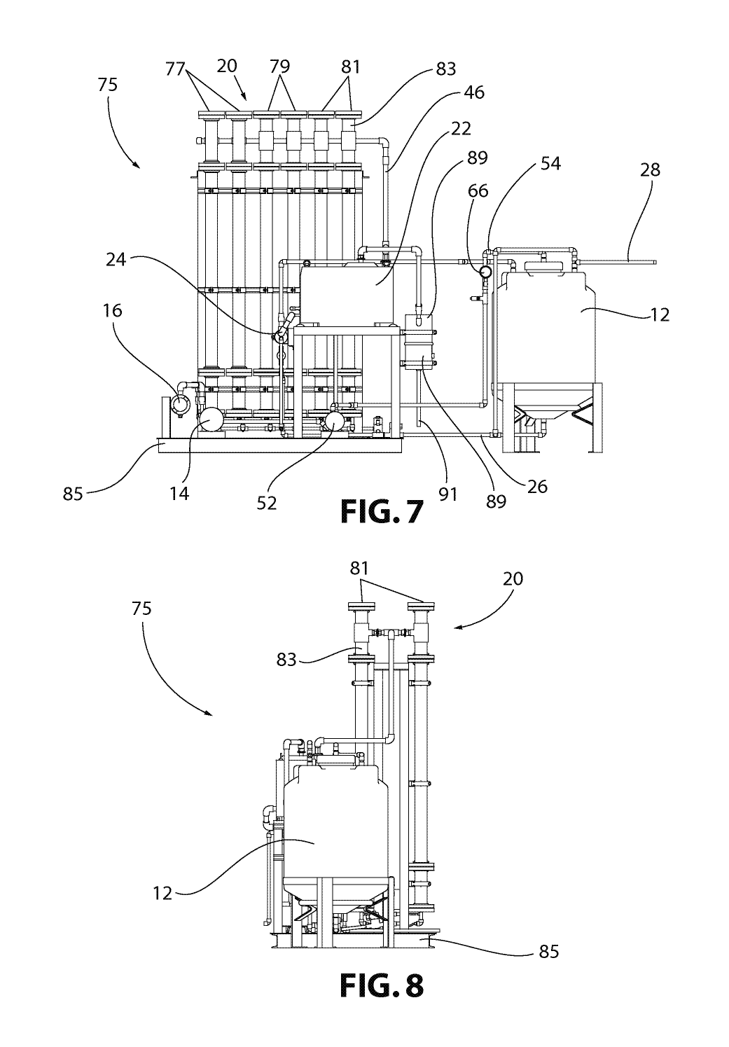

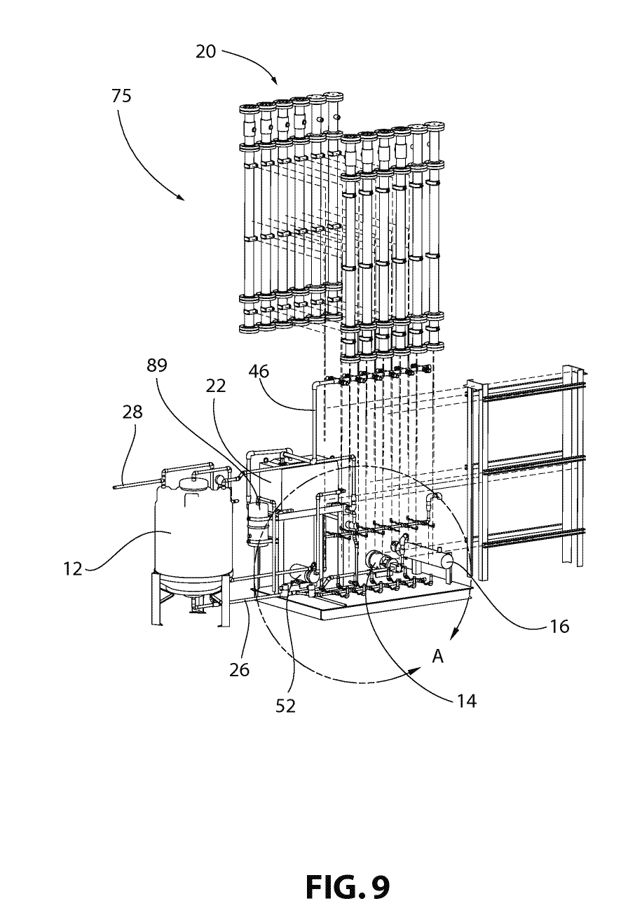

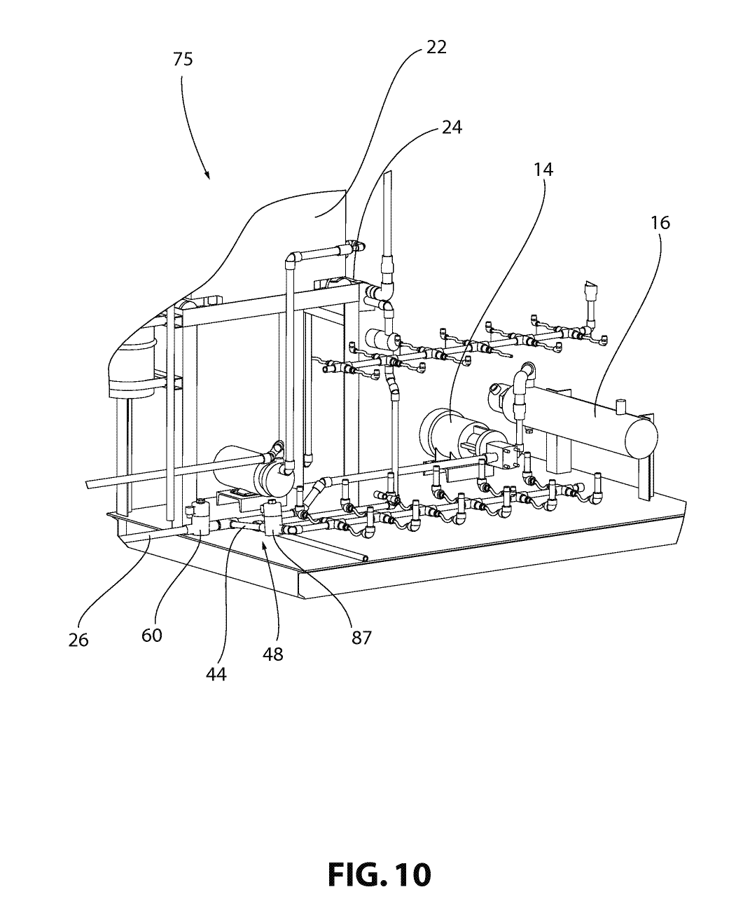

Referring to FIGS. 3-10, a further embodiment of an evaporator or distillation apparatus 75 is disclosed. The apparatus 75 shown in FIGS. 3-10 is similar to the apparatus shown in FIGS. 1 and 2. Like reference numerals are used for like elements. As discussed above in connection with the apparatus 10 shown in FIGS. 1 and 2, the evaporator or distillation apparatus 75 includes a tank 12 for storing influent liquid, a recirculation pump 14, a heater 16, a plurality of cells 20, a vacuum pump 22, and a heat exchanger 24. The apparatus 75 includes twelve cells 20, although other numbers of cells may be utilized. In particular, the apparatus 75 includes an aluminum column assembly 77, a PVC column assembly 79, and a clear PVC column assembly 81 having sight glass 83. As discussed above, however, the cells 20 may be constructed of one or more of PVC, FRP, aluminum, and stainless steel. The apparatus 75, except for the tank 12, is provided on a base 85, although the apparatus 75 may also be supported by any suitable surface. The apparatus 75 further includes a valve 87, such as a solenoid valve, positioned inline with the return line 44. The apparatus 75 also includes a trap and filter unit 89 having an outlet 91 that is connected and in fluid communication with the vacuum pump 22. The apparatus 75 may be operated in the same manner described above in connection with the distillation apparatus 10 shown in FIGS. 1 and 2.

While several embodiments were described in the foregoing detailed description, those skilled in the art may make modifications and alterations to these embodiments without departing from the scope and spirit of the invention. Accordingly, the foregoing description is intended to be illustrative rather than restrictive.

The invention claimed is:

1. An evaporator or distillation apparatus comprising:
an inlet supply line for supplying an influent liquid;
a heater configured to heat the influent liquid supplied by the inlet supply line; and
a plurality of cells, each cell comprising an outer surface defining an interior chamber, an inlet, a vapor outlet, a concentrate outlet, and an inner conduit in fluid communication with the inlet, at least a portion of the inner conduit being positioned within the interior chamber, the vapor outlets of the plurality of cells being connected to each other in a parallel configuration, the inlet supply line being connected to the inlet of each cell.

2. The apparatus of claim 1, further comprising packing material positioned within the interior chamber of each cell.

3. The apparatus of claim 2, wherein the packing material is positioned between the inlet and an upper end of the inner conduit of each cell.

4. The apparatus of claim 3, further comprising a mist eliminator positioned within the interior chamber of each cell.

5. The apparatus of claim 4, wherein the mist eliminator is positioned between the vapor outlet and the upper end of the inner conduit of each cell.

6. The apparatus of claim 1, further comprising a tank for storing the influent liquid, the inlet supply line being in fluid communication with the tank.

7. The apparatus of claim 6, further comprising a heat exchanger in fluid communication with the vacuum pump via a vapor supply line, the heat exchanger having a distillate outlet.

8. The apparatus of claim 7, wherein the heat exchanger comprises a water cooled condenser having a coolant pump connected to a closed-loop coolant line, a portion of the coolant line positioned within the tank for storing the influent liquid.

9. The apparatus of claim 1, further comprising a vacuum pump in fluid communication with the vapor outlet of each cell.

10. A method of evaporating or distilling comprising:
supplying an influent liquid to a plurality of cells;
circulating the influent liquid through a heater and into the plurality of cells;
vaporizing a portion of the influent liquid; and
collecting the vaporized portion of the influent liquid via a vapor supply line, the vapor supply line connecting a vapor outlet of each of the plurality of cells in a parallel configuration.

11. The method of claim 10, further comprising:
applying a vacuum to the plurality of cells such that a pressure within the cells is reduced.

12. The method of claim 11, wherein the vacuum applied to the plurality of cells is about 1-10 Torre.

13. The method of claim 11, further comprising:
compressing the vaporized portion of the influent liquid from the vapor supply line; and
condensing the vaporized portion of the influent liquid.

14. The method of claim 13, wherein the vaporized portion of the influent liquid is condensed by passing the vaporized portion of the influent liquid through a water-cooled condenser.

15. The method of claim 14, further comprising:
circulating coolant through a closed-loop coolant line, a portion of the closed-loop coolant line being positioned within a tank for storing the influent liquid such that heat is transferred from the vaporized portion of the influent liquid to the influent liquid positioned within the tank.

16. The method of claim 10, further comprising:
passing the liquid influent across a packing material positioned within each of the plurality of cells such that a portion of the liquid influent is dispersed into a film.

17. The method of claim 10, wherein each of the plurality of cells have substantially the same temperature and pressure during vaporizing of the influent liquid.

18. The method of claim 10, further comprising:
cleaning one of the plurality of cells while the remaining cells of the plurality of cells continue to receive the circulated influent liquid.
